(19) United States
(12) Patent Application Publication
(10) Pub. No.: US 2001/0044742 A1
(43) Pub. Date: Nov. 22, 2001

(54) Medium on which advertising program is recorded and method of using the medium

(76) Inventors: Jung-wan Ko, Yongin-city (KR); Jae-seong Park, Suwon-city (KR)

Correspondence Address: STAAS & HALSEY LLP, 700 11TH STREET, NW, SUITE 500, WASHINGTON, DC, 20001, US

(21) Appl. No.: 09/736,161

(22) Filed: Dec. 15, 2000

(30) Foreign Application Priority Data
May 19, 2000 (KR) 00-27024

(51) Int. Cl. G06F 17/60

(52) U.S. Cl. 705/14

(57) ABSTRACT

A read-only medium or a readable and writable medium in which a user area is linked to an advertisement, and a method of using the same to minimize the cost to a user and provide advertising. The medium includes an advertising area for recording information related to an advertisement, and a user area from which a user is allowed to read information or to which the user is able to write information when the user views or watches the information recorded in the advertising area. The method of using the medium on which advertisement information is recorded in a predetermined area includes displaying an advertisement recorded in the predetermined area to be viewed or watched by a user; and allowing the user to read or write information from or to a user area on the medium after displaying the advertisement. Accordingly, media can be provided to users at a low price or free, thereby minimizing the financial burden on the users. In addition, advertisers can advertise or publicize business through another medium in addition to conventional media at low cost.

### BACKGROUND OF THE INVENTION

1. Field of the Invention

The present invention relates to a read-only medium, a readable and writable, or a readable and rewritable medium, and more particularly, to a read-only, a readable and writable, or readable and rewritable medium having a reduced cost and providing advertising, and a method of using the same.

2. Description of the Related Art

Optical discs can be classified into read-only media, which are designed for a user to use previously recorded information, and readable and writable media, on which new information can be written. Compact discs (CDs) are read only media, while digital versatile discs (DVDs) and other hybrid discs are writable media. Hybrid discs are high density and multi-functional optical discs on which both reading and writing and/or rewriting can be performed.

Read-only media are used when disc manufacturers provide information which are expected to be needed by users. Accordingly, users may need to purchase many read-only media to obtain desired information. In this case, users (or customers) may be burdened with the cost for purchasing them.

Users can record desired information on recordable media. However, users need to purchase another new medium when the entire area of a given medium is used for recording of information. In this case, also, users are also burdened with the cost. In addition, since recordable media are more expensive than read-only media, the financial burden on users is even greater.

### SUMMARY OF THE INVENTION

To solve the above problems, an object of the present invention is to provide a read-only medium, a readable and writable medium, or a readable and writable medium in which a user area is linked to an advertisement, thereby minimizing the cost to a user and improving advertising efficiency.

Another object of the present invention is to provide a method of using the above medium.

Additional objects and advantages of the invention will be set forth in part in the description which follows and, in part, will be obvious from the description, or may be learned by practice of the invention.

In order to achieve these and other objects, an embodiment of the invention provides a medium which includes an advertising area for recording information related to an advertisement, and a user area from which a user is allowed to read information or to which the user is allowed to write information when the user views or watches the information recorded in the advertising area.

In a further embodiment of the invention, the advertising area is set in either a predetermined area adjacent to a lead-in area, or in two or more separate areas and may be a read-only area or writable area.

In another embodiment of the invention, part of the advertising area may be a read-only area and the other part may be a writable area.

In a still further embodiment of the invention, a method includes displaying an advertisement recorded in the predetermined area to be viewed or watched by a user, and allowing the user to read or write information from or to a user area on the medium after the step.

In another embodiment of the invention, the method includes displaying the advertisement by accessing an advertiser server corresponding to the advertisement recorded on the medium through a communication network either when the medium is loaded in the reading apparatus, or the reading and writing apparatus, when the user requests the use of the user area on the medium, or when an exclusive application program is called to use the medium; checking whether advertisement information that can be updated or needs to be updated exists in the advertisement recorded in the predetermined area when a link to the advertiser server is established; updating the advertisement information upon determining that advertisement information to be updated exists; and displaying the advertisement recorded in the predetermined area to be viewed or watched by the user when it is determined that advertisement information to be updated does not exist or exists and has been updated.

In a yet further embodiment of the invention, the displaying includes, either when the medium is loaded in the reading apparatus or the reading and writing apparatus, when the user requests to use the user area on the medium, or when an exclusive application program is called to use the medium, determining either whether a difference between a time when the medium was last loaded and a time when the medium is presently loaded exceeds a predetermined time or the number of loadings of the medium exceeds a predetermined number; checking whether either a difference between a time when a previous request is made and a time when a current request is made exceeds a predetermined time, whether the number of requests exceeds a predetermined number, whether a difference between a previous call time for the application program and a current call time for the application program exceeds a predetermined time, or whether the number of calls for the application program exceeds a predetermined number; accessing an advertiser server corresponding to the advertisement recorded on the medium through a communication network when it is determined that the predetermined time has elapsed or that more than the predetermined number is counted; checking whether advertisement information that can be updated or needs to be updated exists in the advertisement recorded in the predetermined area when a link to the corresponding advertiser server is established; updating the advertisement information when it is determined that the advertisement information to be updated exists; and displaying the advertisement recorded in the predetermined area to be viewed or watched by the user when either the predetermined time has not yet elapsed, the predetermined number is not reached, the updated advertisement information does not exist, or when the updating of the advertisement information is completed.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram illustrating the relationship between a provider and a customer for explaining the provision of a medium and a method of using the medium according to the present invention;

FIGS. 2A and 2B illustrate examples of the structure of a medium according to the present invention;

FIG. 3 illustrates an example of the screen of an exclusive application program for using a medium according to the present invention; and

FIG. 4 is a flowchart of a method of using a medium according to the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

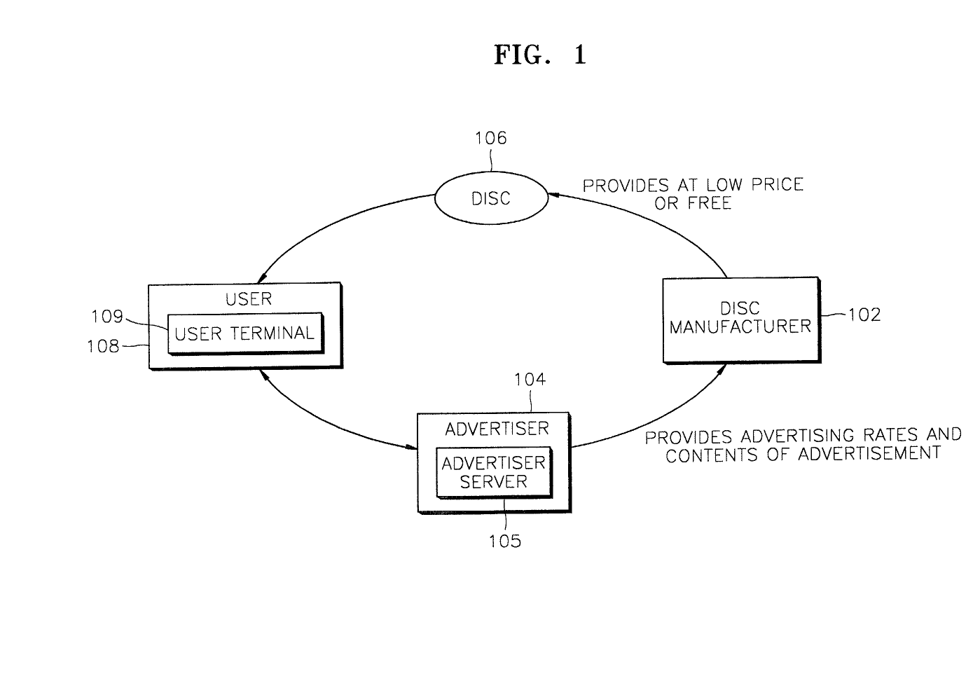

Referring to FIG. 1, the block diagram illustrating the relationship between a provider and a customer includes a disc manufacturer 102, an advertiser 104 having an advertiser server 105, a disc 106 corresponding to a medium according to the present invention, and a user 108 having a user terminal 109.

The disc manufacturer 102 is a provider that provides the disc 106 to the user 108. The disc 106 can be used as a read-only medium, or a readable and writable and/or rewritable medium according to the present invention. The disc manufacturer 102 is paid an advertising rate by the advertiser 104, and the advertiser 104 provides the contents of an advertisement to the disc manufacturer 102 through a conventional method. The provided advertisement content is recorded in a predetermined area on the disc 106. The disc 106 is produced such that the user 108 is allowed to use a user area on the condition that the user 108 views the contents of an advertisement recorded on the predetermined area, which allows the disc 106 to be provided at a low price or for free. The predetermined area is equal to or larger than one sector or one error correction code (ECC) block on the disc 106.

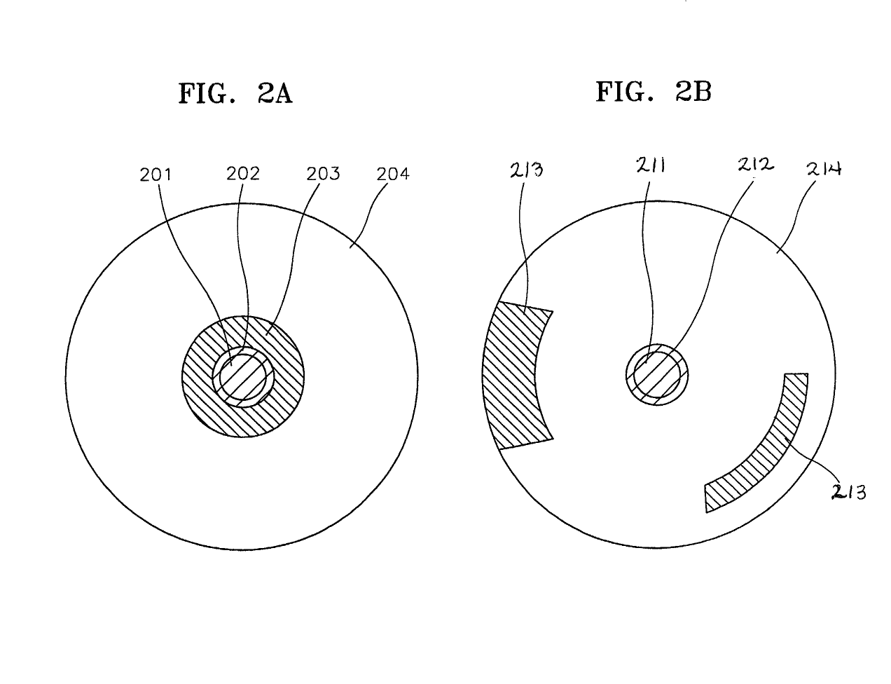

The disc 106 provided by the disc manufacturer 102 may be structured as shown in FIG. 2A or 2B. In the structure of FIG. 2A, a predetermined area adjacent to a lead-in area 201 is set as an exclusive advertising area 203, and the remaining area is set as a user area 204.

In another embodiment of the present invention shown in the FIG. 2B, two separate predetermined areas are set as exclusive advertising areas 213, and the remaining area other than the lead-in area 211 and the exclusive advertising areas 213 is set as the user area 214.

In FIGS. 2A and 2B, the entire exclusive advertising areas 203 and 213 may be set to be read-only areas (areas like read-only memories (ROMs)) or writable areas (areas like random access memories (RAMs)). Alternatively, the entire exclusive advertising areas 203 and 213 may be set such that some area is a read-only area and the other area is a writable area.

More specifically, for the embodiment shown in FIG. 2A, the part of the exclusive advertising area 203 closest to the lead-in area 201 may be set to be a read-only area, and the remaining area may be set to be a writable area. Alternatively, the entire exclusive advertising area 203 may be set to be a read-only area or a writable area.

Similarly, for the embodiment shown in FIG. 2B, one of the two separate exclusive advertising areas 213 may be set to be a writable area, and the other may be set to be a read-only area. Alternatively, the two areas may be set to be read-only areas or writable areas. Whenever located, a writable exclusive advertising area can be updated with new advertising contents by the advertiser server 105 of the advertiser 104. It is understood that additional areas other than those illustrated in FIG. 2B may be set as an exclusive advertising area on the disc 106.

The lead-in areas 201 and 211 have the same uses as conventional ones. In addition, control information, which is necessary for allowing a user to use a user area on the condition that the user watches or views an advertisement provided through the disc 106, is recorded in file system areas 202 and 212 existing in the lead-in areas 201 and 211, respectively. For example, when the disc 106 is designed to have user 108 watch or view an advertisement recorded on the disc 106 when the disc 106 is loaded in the user terminal 109, the related control information is recorded in the file system area 202 or 212 so that an advertisement recorded in the exclusive advertising area 203 or 213 must be read before the user area 204 or 214 is used.

The user terminal 109 is an apparatus capable of reading or reading and writing with respect to the loaded disc 106. For example, the user terminal 109 could be a computer having an optical disc driving function and a communication function, or an optical disc driving apparatus having a communication function. The user terminal 109 operates based on the information recorded in the file system area 202 or 212 such that the user 108 can use the user area 204 or 214 only after the user 108 watches or views the contents of an advertisement recorded in the exclusive advertising area 203 or 213. This viewing occurs either when the disc 106 is loaded in the user terminal 109, when the user's request for using the user area 204 or 214 on the loaded disc 106 is generated, or when an exclusive application program for using the disc 106 is called by the user 108.

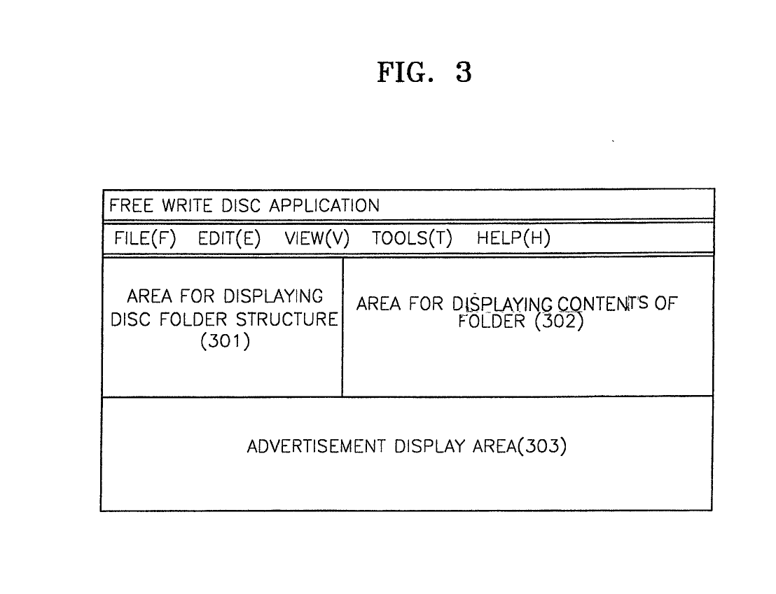

FIG. 3 illustrates an example of the screen of an exclusive application program for using the disc according to an embodiment of the present invention. This application program is called when the user 108 writes or reads information to or from the user area 204 or 214 on the disc 106 loaded in the user terminal 109. As shown in FIG. 3, this application program includes an area 301 for displaying a disc folder structure of the user area 204 or 214, an area 302 for displaying the contents of a folder to inform the user 108 of the detailed contents of the folder, and an advertisement display area 303 for displaying the contents of an advertisement recorded in the exclusive advertising area 203 or 213 on the disc 106. The contents of an advertisement displayed on the advertisement display area 303 has the form of a banner.

Is understood that other modes of advertising can be employed using the present invention. For instance, audio advertisements, audio and video advertisements, or other multimedia advertisements can be provided in order to more effectively advertise a product or service.

Whichever form is used, the advertiser 104 provides the advertisement contents and advertising rates to the disc manufacturer 102 through a conventional method. The advertiser server 105 provides new advertisement contents to be updated to the user terminal 109 through a communication network. The advertiser 104 obtains the effect of the advertisement from the user 108. Communication between the advertiser server 105 and the user terminal 109 can be accomplished through the Internet, a digital data broadcasting network, an ordinary wire/wireless communication network, e-mail or other communication mechanisms.

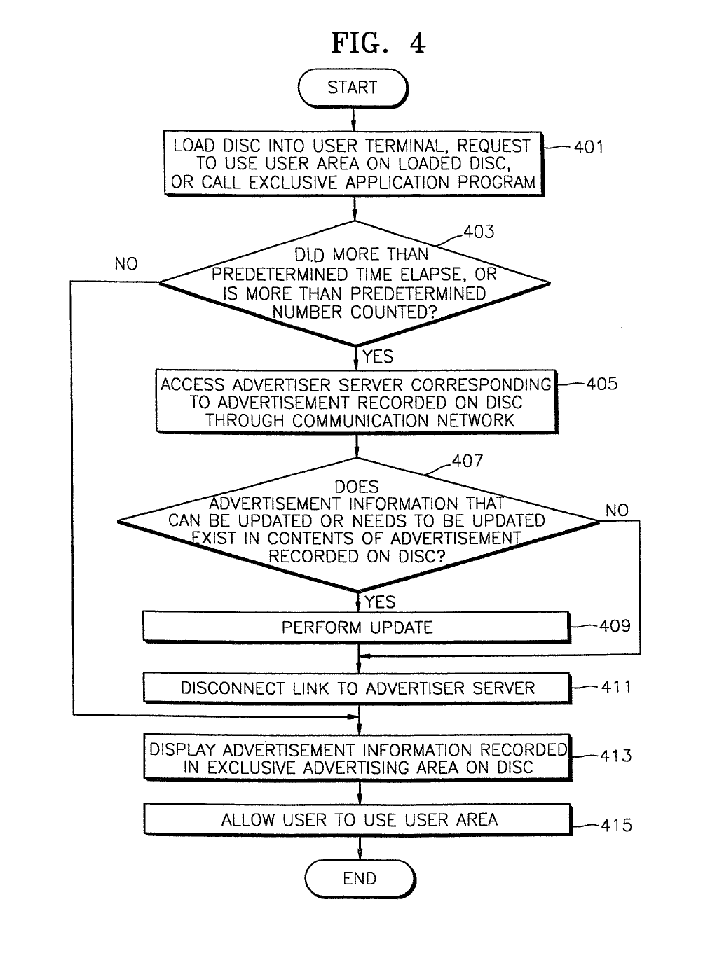

FIG. 4 is a flowchart of a method of using a medium according to an embodiment of the present invention. When either the disc 106 is loaded in the user terminal 109, the user 108 requests the use of a user area on the loaded disc 106 through the user terminal 109, or the user 108 calls an exclusive application program through the user terminal 109 in step 401, it is checked whether more than a predetermined time elapsed or more than a predetermined number of the above events are counted in step 403.

More specifically, where the disc 106 is configured such that an advertisement recorded on the disc 106 is presented when the disc 106 is loaded in the user terminal 109, in step 403, the user terminal 109 detects the difference between a time when the disc 106 was last loaded and a time when the disc 106 is presently loaded, and checks whether the detected difference exceeds a predetermined time. Alternatively, the user terminal 109 may count whenever the disc 106 is loaded, and check whether the counted value exceeds a predetermined number.

Where the disc 106 is configured such that the user terminal 109 operates depending on a user's request for using a user area in step 401, the user terminal 109 detects the difference between a time when a request for using the user area was last made and a time when a request for using the user area is presently made, and checks whether the detected difference exceeds a predetermined time, in step 403. Alternatively, the user terminal 109 may count whenever a use request is made and check whether the counted value exceeds a predetermined number.

Where the disc 106 is configured such that the user terminal 109 calls an exclusive application program in step 401, the user terminal 109 detects the difference between a time when the exclusive application program was last called and a time when the exclusive application program is presently called, and checks whether the detected difference exceeds a predetermined time, in step 403. Alternatively, the user terminal 109 may count whenever the exclusive application program is called and check whether the counted value exceeds a predetermined number.

The disc 106 may be programmed such that the user terminal 109 accommodates both checking methods, or uses either in each of the three cases described above. In other words, a predetermined time and a predetermined number of times may be selectively considered, or only one of them may be considered.

When it is determined that more than the predetermined time has elapsed or more than the predetermined number is counted in step 403, the user terminal 109 accesses the advertiser server 105 corresponding to an advertisement recorded on the disc 106, through a communication network in step 405. The access is performed by forwarding identification information on the advertiser 104 recorded in the file system area 202 or 212. Accordingly, the advertiser server 105 having the same identification information as the forwarded identification information is linked to the user terminal 109.

When the link between the advertiser server 105 and the user terminal 109 is established in step 405, the user terminal 109 checks whether advertisement information that can be updated or needs to be updated exists in the contents of an advertisement recorded in the exclusive advertising area 203 or 213 on the disc 106 in step 407. The checking is performed by data transmission and reception between the advertiser server 104 and the user terminal 109.

When it is determined that updated advertisement contents exist, the user terminal 109 receives new corresponding advertisement contents from the advertiser server 105 and updates the advertisement content in step 409. This updated advertisement can be stored on the optical disc, on another disc such as a hard disc, or not stored at all. The steps 407 and 409 are performed on a single frame or a single advertising unit. Thereafter, the user terminal 109 disconnects the link to the advertiser server 105 in step 411.

Conversely, when it is determined that no advertisement information that can be updated or needs to be updated exists in the contents of an advertisement recorded on the disc in step 407, the method proceeds directly to step 411, and the user terminal 109 disconnects the link to the advertiser server 105.

When it is determined either that the time difference or the counted value checked with respect to the loading of a disc, a user's request to use a user area or a call of an application program does not exceed the predetermined time or the predetermined number in step 403, or when the link to the advertiser server 105 is disconnected in step 411, the user terminal 109 displays the contents of the advertisement recorded in the exclusive advertising area 203 or 213 on the disc 106 in step 413. The user terminal 109 allows the user 108 to use the user area in step 415. Accordingly, the user 108 can read information from the user area or read and write information from and/or to the user area.

For the embodiment of the present invention shown in FIG. 4 described above, while showing the three cases being simultaneously processed in the steps 401 and 403, it is understood that they may be separately processed. In other words, the present invention may be implemented such that the method shown in FIG. 4 is operated in response to either only the loading of the disc 106 into the user terminal 109, only the user requesting the use of the user area on the loaded disc 106, or only at the calling for the exclusive application program, or any combination of the three conditions.

A plurality of advertisements provided from a plurality of advertisers may be recorded on a single disc. In this case, when the disc is sequentially accessed, the advertisements may be sequentially displayed or may be displayed in a predetermined order. In addition, information on the number of accesses to the advertisements and information on the order of accessing the advertisements can be recorded and managed in a file system area on a recordable disc area.

The present invention provides a read-only medium or a readable and writable medium, where a readable and writable medium generally refers to either readable and writable or readable and rewritable media. The medium includes an exclusive advertising area and a user area and is programmed such that the user area can be used on the condition that a user views, hears, or otherwise receives an advertisement recorded on the exclusive advertising area, to a user at a low price or for free, and a method of using the same, thereby minimizing the cost of the user purchasing a read-only medium or a readable and writable rewritable medium. Consequently, the market of the above medium can be expected to flourish. The medium may be optical, magnetic, or otherwise suitable for the reading/writing of information, and may contain programs, music, videos, or other information.

In addition, an advertiser can advertise, publicize businesses, or otherwise provide advertisements through another medium in addition to conventional media, thereby expanding the range of advertising or public relations and saving the cost for advertisement. The provided advertisements can be in audio, video, or any other form through which advertisements can be made through a communication network.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A medium comprising:
an advertising area for recording information related to an advertisement; and
a user area from which a user is allowed to read information from the medium or to which the user is allowed to write information to the medium when the user receives the information recorded in said advertising area.

2. The medium of claim 1, further comprising a lead-in area, wherein said advertising area is provided a predetermined area adjacent to said lead-in area.

3. The medium of claim 2, wherein the predetermined area is a read-only area.

4. The medium of claim 2, wherein the predetermined area is divided into a read-only area and a writable area.

5. The medium of claim 2, wherein the predetermined area is a writable area.

6. The medium of claim 1, wherein said advertising area is set in separate areas.

7. The medium of claim 6, wherein the separate areas are read-only areas.

8. The medium of claim 6, wherein the separate areas are writable areas.

9. The medium of claim 6, wherein at least one of the separate areas is a read-only area, and the other areas are writable areas.

10. The medium of claim 6, wherein at least one of the separate areas is a writable area, and the other areas are read-only areas.

11. The medium of claim 1, further comprising a file system area in which information related to said advertising area is recorded so that the user receives the advertisement when the medium is loaded in a either reading apparatus or a reading and writing apparatus.

12. The medium of claim 1, further comprising a file system area in which information related to the advertising area is recorded so that the advertisement related information is displayed when the user attempts to read information from the medium for the first time.

13. The medium of claim 1, further comprising a file system area in which information related to said advertising area is recorded so that the user receives the advertisement based on an application program which the user calls to write or read information to or from said user area.

14. The medium of claim 1, further comprising a file system area in which identification information on an advertiser is recorded to allow the information in said advertising area to be updated with data provided by the advertiser through a communication network.

15. The medium of claim 1, wherein said advertising area comprises recorded advertisement contents from a plurality of advertisers.

16. The medium of claim 15, further comprising a file system area in which information for allowing the advertisement contents recorded in said advertising area to be sequentially accessed is recorded.

17. The medium of claim 15, further comprising a file system area in which information related to a predetermined order is recorded to allow the advertisement contents recorded in said advertising area to be accessed according to the predetermined order.

18. The medium of claim 1, further comprising a file system area having a record of a number of accesses made to an advertisement recorded in said advertising area.

19. A method of using a medium on which advertisement information is recorded in a predetermined area, the method comprising:
displaying an advertisement recorded in the predetermined area; and
allowing the user to read or write information from or to a user area on the medium after said displaying the advertisement.

20. The method of claim 19, wherein said displaying the advertisement is performed in response to the user loading the medium in the reading apparatus or the reading and writing apparatus.

21. The method of claim 19, wherein said displaying the advertisement comprises:
accessing through a communication network an advertiser server corresponding to the advertisement when the medium is loaded in either the reading apparatus or the reading and writing apparatus;
checking whether advertisement information that can be updated or needs to be updated exists for the advertisement when a link to the advertiser server is established;
updating the advertisement information upon determining that updated advertisement information exists; and
displaying the advertisement upon determining whether advertisement information to be updated exists, and updating the advertisement information if necessary.

22. The method of claim 21, wherein the checking and updating are performed on a single frame or a single advertising unit.

23. The method of claim 21, wherein the checking whether advertisement information is updateable is performed through communication with the advertiser server.

24. The method of claim 20, wherein said displaying the advertisement comprises:
determining whether a difference between a time when the medium was last loaded and a time when the medium is presently loaded exceeds a predetermined time, or whether the number of loadings of the medium exceeds a predetermined number, when the medium is loaded into the reading apparatus or the reading and writing apparatus;
accessing an advertiser server corresponding to the advertisement through a communication network, upon determining that more than the predetermined time has elapsed or that more than the predetermined number is counted;
checking whether advertisement information that can be updated or needs to be updated exists for the advertisement when a link to the corresponding advertiser server is established;
updating the advertisement information upon determining that the updated advertisement information exists; and
displaying the advertisement when the predetermined time has not yet elapsed, when the predetermined number is not counted yet reached, the updated advertisement information does not exist, or when the advertisement information is updated.

25. The method of claim 21, wherein the accessing the communication network comprises forwarding identification information on the advertiser server through the communication network to perform the access.

26. The method of claim 19, wherein said displaying the advertisement is performed when a reading or writing operation on the user area on the medium is requested by the user.

27. The method of claim 26, wherein said displaying comprises:
checking whether a difference between a previous request time and a current request time exceeds a predetermined time or whether a number of requests exceeds a predetermined number when the reading or writing operation on the user area is requested;
accessing an advertiser server corresponding to the advertisement through a communication network, when more than the predetermined time has elapsed or more than the predetermined number is counted;
checking whether advertisement information that can be updated or needs to be updated exists for the advertisement when a link to the corresponding advertiser server is established;
updating the advertisement information upon determining that the updated advertisement information exists; and
displaying the advertisement upon determining that the predetermined time has not elapsed, the predetermined number of times has not yet been counted, the updated advertisement information does not exist, or when the advertisement information is updated.

28. The method of claim 19, wherein said displaying the advertisement is performed such that the advertisement is displayed to the user through a predetermined area of an application program when the application program for performing reading or writing on the user area on the medium is called by the user.

29. The method of claim 28, wherein said displaying the advertisement comprises:
determining whether a difference between a previous call time for the application program and a current call time for the application program exceeds a predetermined time, or whether a number of calls for the application program exceeds a predetermined number;
accessing an advertiser server corresponding to the advertisement through a communication network, when more than the predetermined time has elapsed or more than the predetermined number is counted;
checking whether advertisement information that can be updated or needs to be updated exists for the advertisement when a link to the corresponding advertiser server is established;
updating the advertisement information upon determining that the advertisement information exists; and
displaying the advertisement when the predetermined time has not yet elapsed, if the predetermined number has not yet been reached, the updated advertisement information does not exist, or when the advertisement information has been updated.

30. The method of claim 28, wherein the displayed application program includes an area for displaying the folder structure of the medium, an area for displaying the contents of the folder, and an area for displaying the advertisement.

31. The method of claim 30, wherein the displayed application program displays the advertisement in the form of a banner through the area for displaying the advertisement.

32. The method of claim 19, wherein said displaying the advertisement comprises:
sequentially accessing advertisement contents from a plurality of advertisers, which are recorded in the predetermined area; and
displaying the advertisement contents according to an order in which the contents are accessed.

33. The method of claim 19, wherein said displaying the advertisement comprises:
accessing the advertisement contents from a plurality of advertisers, which are recorded in the predetermined area, according to a predetermined order; and
displaying the advertisement contents to the user according to the predetermined order.

34. The method of claim 32, further comprising recording and managing the number of accesses to each advertisement displayed.

35. A method of using a disc on which at least one advertisement of at least one advertiser is recorded in a predetermined area by a disc manufacturer, the method comprising:
accessing the server of the advertiser through a communication network when the disc is loaded into a user terminal;
checking whether advertisement information that can be updated or needs to be updated exists in the advertisement recorded on the disc when the access to the advertiser server is effected;
updating the advertisement information upon determining that advertisement information exists;
displaying the advertisement upon determining whether the advertisement information exists and updating the advertisement as necessary; and
allowing the user to perform reading or writing on a user area on the disc after said displaying the advertisement.

36. The method of claim 35, wherein said accessing the server comprises either checking whether a difference between a time when the disc was last loaded and a time when the disc is presently loaded exceeds a predetermined time, or whether a number of loadings of the disc exceeds a predetermined number, and attempting to access to the advertiser server when more than the predetermined time has elapsed, or when more than the predetermined number is counted.

37. A computer readable medium encoded with processing instructions for implementing a method of using a medium on which advertisement information is recorded in a predetermined area, the method comprising:
providing an advertisement recorded in the predetermined area to a user; and
allowing the user to read or write information from or to a user area on the medium after said providing the advertisement.

38. The computer readable medium of claim 37, wherein said providing the advertisement is performed when the user loads the medium in the reading apparatus or the reading and writing apparatus.

39. The computer readable medium of claim 37, wherein said providing the advertisement comprises:
accessing through a communication network an advertiser server corresponding to the advertisement when the medium is loaded in either the reading apparatus or the reading and writing apparatus;
checking whether advertisement information that can be updated or needs to be updated exists for the advertisement when a link to the advertiser server is established;
updating the advertisement information upon determining that updated advertisement information exists; and
providing the advertisement to the user upon determining whether advertisement information to be updated exists, and updating the advertisement information if necessary.

40. The computer readable medium of claim 39, wherein the checking and updating are performed on a single frame or a single advertising unit.

41. The computer readable medium of claim 39, wherein the checking whether advertisement information is updateable is performed through communication with the advertiser server.

42. The computer readable medium of claim 38, wherein said providing the advertisement comprises:
determining whether a difference between a time when the medium was last loaded and a time when the medium is presently loaded exceeds a predetermined time, or whether the number of loadings of the medium exceeds a predetermined number, when the medium is loaded into the reading apparatus or the reading and writing apparatus;
accessing an advertiser server corresponding to the advertisement through a communication network, upon determining that more than the predetermined time has elapsed or that more than the predetermined number is counted;
checking whether advertisement information that can be updated or needs to be updated exists for the advertisement when a link to the corresponding advertiser server is established;
updating the advertisement information upon determining that the updated advertisement information exists; and
providing the advertisement to the user when the predetermined time has not yet elapsed, when the predetermined number is not yet reached, the updated advertisement information does not exist, or when the advertisement information is updated.

43. The computer readable medium of claim 39, wherein the accessing the communication network comprises forwarding identification information on the advertiser server through the communication network to perform the access.

44. The computer readable medium of claim 37, wherein said providing the advertisement is performed when a reading or writing operation on the user area on the medium is requested by the user.

45. The computer readable medium of claim 44, wherein said providing comprises:
checking whether a difference between a previous request time and a current request time exceeds a predetermined time or whether the number of requests exceeds a predetermined number when the reading or writing operation on the user area is requested;
accessing an advertiser server corresponding to the advertisement through a communication network, when more than the predetermined time has elapsed or that more than the predetermined number is counted;
checking whether advertisement information that can be updated or needs to be updated exists for the advertisement when a link to the corresponding advertiser server is established;
updating the advertisement information upon determining that the updated advertisement information exists; and
providing the advertisement to the user upon determining that the predetermined time has not elapsed, the predetermined number of times has not yet been counted, the updated advertisement information does not exist, or when the advertisement information is updated.

46. The computer readable medium of claim 37, wherein said providing the advertisement is performed such that the advertisement is displayed to the user through a predetermined area of an application program when the application program for performing reading or writing on the user area on the medium is called by the user.

47. The computer readable medium of claim 46, wherein said providing the advertisement comprises:
determining whether a difference between a previous call time for the application program and a current call time for the application program exceeds a predetermined time, or whether the number of calls for the application program exceeds a predetermined number;
accessing an advertiser server corresponding to the advertisement through a communication network, when more than the predetermined time has elapsed or more than the predetermined number is counted;
checking whether advertisement information that can be updated or needs to be updated exists for the advertisement when a link to the corresponding advertiser server is established;
updating the advertisement information upon determining that the advertisement information exists; and
providing the advertisement to the user when the predetermined time has not yet elapsed, if the predetermined number has not yet been reached, the updated advertisement information does not exist, or when the advertisement information has been updated.

48. The computer readable medium of claim 46, wherein the application program includes an area for displaying the folder structure of the medium, an area for displaying the contents of the folder, and an area for displaying the advertisement.

49. The computer readable medium of claim 48, wherein the application program displays the advertisement recorded in the form of a banner through the area for displaying the advertisement.

50. The computer readable medium of claim 37, wherein said providing the advertisement comprises:
sequentially accessing advertisement contents from a plurality of advertisers, which are recorded in the predetermined area; and
providing the advertisement contents to the user according to an order in which the contents are accessed.

51. The computer readable medium of claim 37, wherein said providing the advertisement comprises:
accessing the advertisement contents from a plurality of advertisers, which are recorded in the predetermined area, according to a predetermined order; and
providing the advertisement contents to the user according to the predetermined order.

52. The computer readable medium of claim 50, further comprising recording and managing the number of accesses to each advertisement displayed.

53. The computer readable medium of claim 37, wherein said providing the advertisement comprises displaying the advertisement using video.

54. The computer readable medium of claim 37, wherein said providing the advertisement comprises playing the advertisement as audio.
